(19) United States
(12) Patent Application Publication
(10) Pub. No.: US 2006/0216528 A1
(43) Pub. Date: Sep. 28, 2006

(54) Nanoparticle structure and method of manufacturing the same

(75) Inventors: Joo-hyun Lee, Seoul (KR); Yoon-ho Khang, Yongin-si (KR); Eun-hye Lee, Seoul (KR)

Correspondence Address: BUCHANAN, INGERSOLL & ROONEY PC, POST OFFICE BOX 1404, ALEXANDRIA, VA, 22313-1404, US

(73) Assignee: Samsung Electronics Co., Ltd., Suwon-si (KR)

(21) Appl. No.: 11/353,983

(22) Filed: Feb. 15, 2006

(30) Foreign Application Priority Data
Feb. 19, 2005 (KR) 10-2005-0013900

(51) Int. Cl. B32B 5/16; C23C 8/00; B05D 3/02

(52) U.S. Cl. 428/432; 428/331; 427/585; 427/372.2

(57) ABSTRACT

The nanoparticle structure includes: a substrate; and nanoparticles formed on the substrate, wherein the nanoparticles include silicide. The method of manufacturing the nanoparticle structure includes: forming an Si source layer to a predetermined thickness; forming nanoparticles using a predetermined metal and silicon; depositing the nanoparticles on the Si source layer; and growing the nanoparticles to form silicide. Nanoparticles having a desired size can be easily obtained by adjusting the thickness of the silicon source layer.

### CROSS-REFERENCE TO RELATED PATENT APPLICATIONS

Priority is claimed to Korean Patent Application No. 10-2005-0013900, filed on Feb. 19, 2005, in the Korean Intellectual Property Office, the disclosure of which incorporated herein in its entirety by reference.

### BACKGROUND OF THE INVENTION

1. Field of the Disclosure

The present disclosure relates to a nanoparticle structure, and more particularly, to a stack structure of self-limiting nanoparticles using a predetermined metal and silicon and a method of manufacturing the same.

2. Description of the Related Art

In general, methods of manufacturing nanoparticles include thermal decomposition and laser ablation.

In thermal decomposition, nanoparticles are manufactured using a precursor. This method is comparatively simple; however, due to the low concentration of the precursor, the yield of nanoparticles is low.

In laser ablation, a target is sputtered by using a laser beam and nanoparticles are obtained from the target. In this case, the density of nanoparticles to be formed on a wafer is low, and in order to increase the density of nanoparticles, a time required for depositing the nanoparticles on the wafer should be increased. However, since laser ablation is performed within a very short time, it is difficult to obtain nanoparticles having a desired size.

### SUMMARY OF THE DISCLOSURE

The present disclosure provides a nanoparticle structure of which nanoparticles have a predetermined size obtained by adjusting the thickness of a silicon source layer, and a method of manufacturing the nanoparticle structure.

According to an aspect of the present disclosure, there is provided a nanoparticle structure including: a substrate; and nanoparticles formed on the substrate, wherein the nanoparticles include silicide.

The silicide may be a silicide of one element selected from the group consisting of Au, Fe, Al, Co, Ni, Cu, Ag, and Pt.

The nanoparticles may be formed through laser ablation.

The nanoparticles may be grown through post annealing.

A post annealing temperature may be 360° C. to 1400° C., for example, 600° C. to 800° C.

The substrate may include silicon.

The nanoparticle structure may further include an insulating layer between the nanoparticles and the substrate.

The insulating layer may be formed of at least one high-dielectric material selected from the group consisting of SiO₂, Si₃N₄, Ta₂O₃, ZrO₂, Al₂O₃, HfO₂, HfSiO₄, and HfAlO₄.

The nanoparticles may be substantially formed in a spherical form.

According to another aspect of the present invention, there is proved a method of manufacturing a nanoparticle structure, the method including: forming an Si source layer to a predetermined thickness; forming nanoparticles using a predetermined metal and silicon; depositing the nanoparticles on the Si source layer; and growing the nanoparticles to form silicide.

The metal may include at least one selected from the group consisting of Au, Fe, Al, Co, Ni, Cu, Ag, and Pt.

The forming of the nanoparticles may be performed through laser ablation.

The growing of the nanoparticles may be performed through post annealing.

A post annealing temperature may be 360° C. to 1400° C.

The forming of the Si source layer may include: preparing a substrate; and forming an insulating layer on the substrate; and forming the Si source layer on the insulating layer.

The substrate may include silicon.

The insulating layer may be formed of at least one high-dielectric material selected from the group consisting of SiO₂, Si₃N₄, Ta₂O₃, ZrO₂, Al₂O₃, HfO₂, HfSiO₄, and HfAlO₄.

In the nanoparticle structure and the method of manufacturing the same according to the present disclosure, the size of nanoparticles can be adjusted by adjusting the thickness of the silicon source layer such that nanoparticles having a desired size can be easily obtained.

### BRIEF DESCRIPTION OF THE DRAWINGS

The above and other aspects of the present invention will become more apparent by describing in detail exemplary embodiments thereof with reference to the attached drawings in which:

FIGS. 1A through 1C illustrate a method of manufacturing nanoparticles according to an embodiment of the present invention;

FIGS. 2A through 2E illustrate a method of manufacturing a nanoparticle structure according to another embodiment of the present invention;

FIGS. 3A and 3B illustrate experimental examples of the size of nanoparticles using different thicknesses of a silicon source layer in a nanoparticle structure and a method of manufacturing the nanoparticle structure according to the present disclosure;

FIGS. 4A through 4D illustrate experimental examples of the size of nanoparticles using different internal temperatures of a furnace in which a post annealing operation is performed, in a nanoparticle structure and a method of manufacturing the nanoparticle structure according to the present disclosure; and

FIG. 5 is a graph showing the results of FIGS. 4A through 4D.

### DETAILED DESCRIPTION OF EXEMPLARY EMBODIMENTS

Hereinafter, the present invention will be described in detail by explaining exemplary embodiments of the invention with reference to the attached drawings. Like reference numerals in the drawings denote like elements.

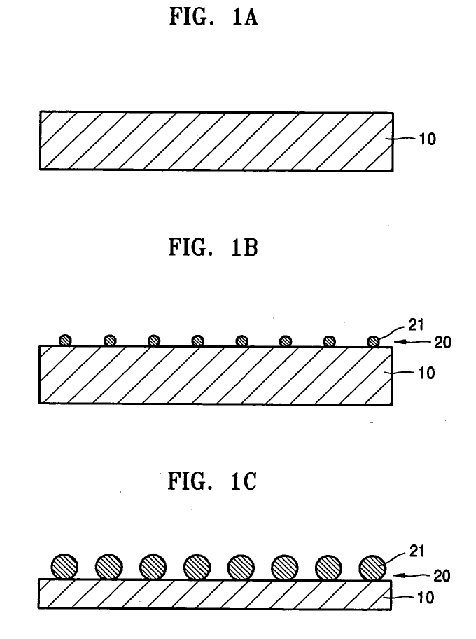

FIGS. 1A through 1C illustrate a method of manufacturing a nanoparticle structure according to an embodiment of the present invention.

Referring to FIG. 1A, first, a substrate 10 is prepared. The substrate 10 includes silicon (Si) and serves as an Si source layer for forming nanoparticles 21.

Referring to FIG. 1B, the nanoparticles 21 are deposited on the substrate 10, a plurality of the nanoparticles 21 forming a nanoparticle layer 20.

In an embodiment of the present invention, the nanoparticles 21 may be formed through laser ablation. Specifically, if a powder target formed of Au and Si is laser-ablated, nanolevel particles are formed. If the nanolevel particles formed in this way are deposited on the substrate 10, the nanoparticles 21 are formed of Au and Si.

Although the nanoparticles 21 are formed of Au and Si in the present embodiment, other powder metals may be used instead of the Au powder target.

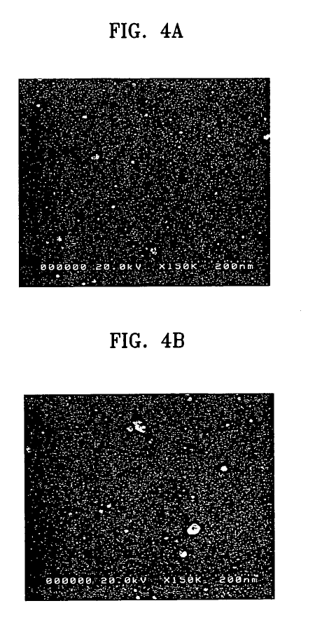

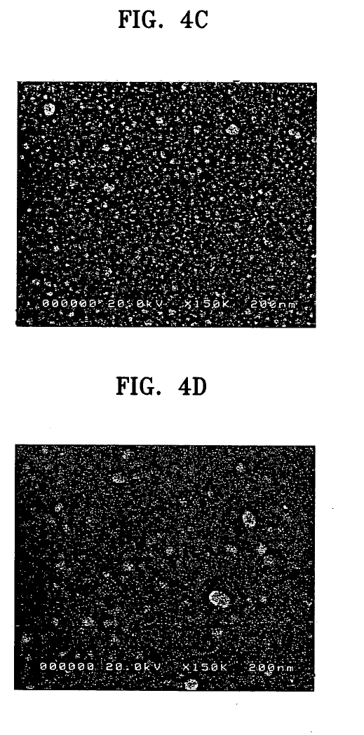

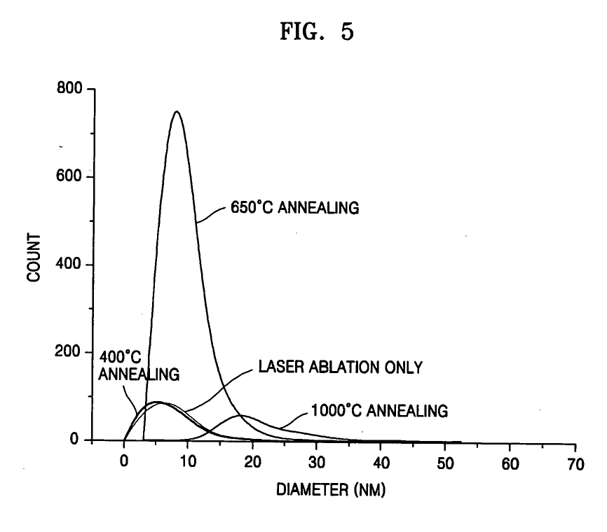

Referring to FIG. 1C, the nanoparticles 21 are grown on the substrate 10. In an embodiment of the present invention, the nanoparticles 21 may be grown by performing a post annealing operation, which may be performed in an Ar, N₂, or He atmosphere. An internal temperature of a furnace in which the post annealing operation is performed may be from 360° C. to 1400° C., preferably, 600° C. to 800° C. This will be described later with reference to FIGS. 4A through 4D and FIG. 5.

In an embodiment of the present invention, the nanoparticles 21 formed of Au and Si serve as seeds and silicon is supplied to the nanoparticles 21 from the substrate 10 to grow the nanoparticles 21. In this case, the nanoparticels 21 become Au-silicide. When the nanoparticles 21 are grown as described above, the nanoparticles 21 may be grown in a spherical form.

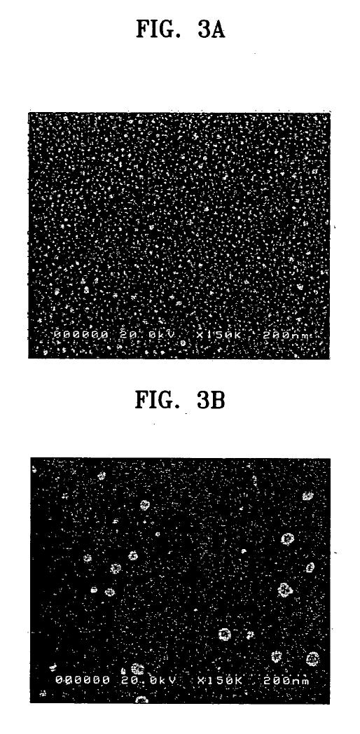

A thickness of the substrate 10 is adjusted so that the size of the nanoparticles 21 obtained by growing the nanoparticles 21 can be adjusted. This will be described later with reference to FIGS. 3A and 3B.

FIGS. 3A and 3B illustrate experimental examples of the size of nanoparticles using different thicknesses of a silicon source layer in a nanoparticle structure and a method of manufacturing the nanoparticle structure according to the present disclosure.

FIG. 3A shows an experimental result of the size of nanoparticles in which the thickness of the silicon source layer is set to 2 nm, and FIG. 3B shows an experimental result of the size of nanoparticles in which the thickness of the silicon source layer is set to 8 nm. Only the thickness of the silicon source layer shown in FIGS. 3A and 3B, respectively, as described above, is different, and other experimental conditions are the same.

Referring to FIGS. 3A and 3B, the size of nanoparticles to be formed when the thickness of the silicon source layer is 8 nm is larger than the size of nanoparticles formed when the thickness of the silicon source layer is 2 nm. That is, the size of the nanoparticles is determined according to the thickness of the silicon source layer. Thus, by adjusting the thickness of the silicon source layer, the nanoparticles having a required size can be easily obtained.

Referring to FIGS. 3A and 3B, according to the present disclosure, the nanoparticles can be formed in a spherical form.

FIGS. 4A through 4D illustrate experimental examples of the size or density of nanoparticles using different internal temperatures of a furnace in which a post annealing operation is performed, in a nanoparticle structure and a method of manufacturing the nanoparticle structure according to the present disclosure, and FIG. 5 is a graph showing the results of FIGS. 4A through 4D.

FIG. 4A shows an experimental result of the size of nanoparticles in which nanoparticles are deposited through laser ablation and a post annealing operation is not performed, FIG. 4B shows an experimental result of the size of nanoparticles in which the internal temperature of a furnace in which a post annealing operation is performed is set to 400° C., FIG. 4C shows an experimental result of the size of nanoparticles in which the internal temperature of a furnace in which a post annealing operation is performed is set to 650° C., and FIG. 4D shows an experimental result of the size of nanoparticles in which the internal temperature of a furnace in which a post annealing operation is performed is set to 1000° C.

The experimental examples will now be described in detail.

First, Au powder (1-3 μm, 99.9%, Sigma Aldrich) and silicon powder (1 μm, 99%, Sigma Aldrich) are mixed with each other to manufacture a target for laser ablation.

After that, nanoparticles formed by laser-ablating the Au/silicon target are deposited on a silicon/SiO₂/silicon wafer for 20 seconds.

After that, the nanoparticles are annealed at 450° C. to 1000° C. in an Ar atmosphere.

Referring to FIGS. 4A and 4B, the size or density of the nanoparticles does not change before and after performing the post annealing operation at 450° C. When the post annealing operation is performed at 650° C., according to FIG. 4C, the density of the nanoparticles increase greatly and the size thereof also increases. Referring to FIG. 4D, when the post annealing operation is performed at 1000° C., the nanoparticles are coagulated and the size of the nanoparticles also increases greatly. As such, a proper temperature required for growing nanoparticles is about 650° C. and the temperature has a close relation with a phase diagram of Au and Si. Au/Si nanoparticles are grown at a temperature at which Au/Si nanoparticles are in a liquid state and Si nanoparticles are in a solid state.

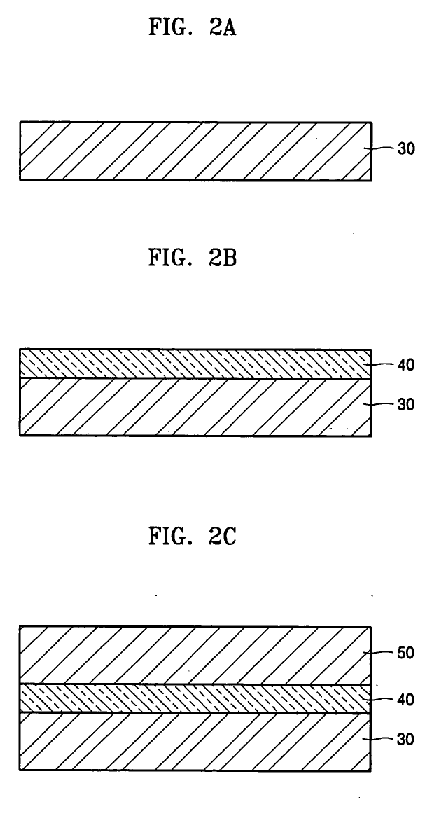

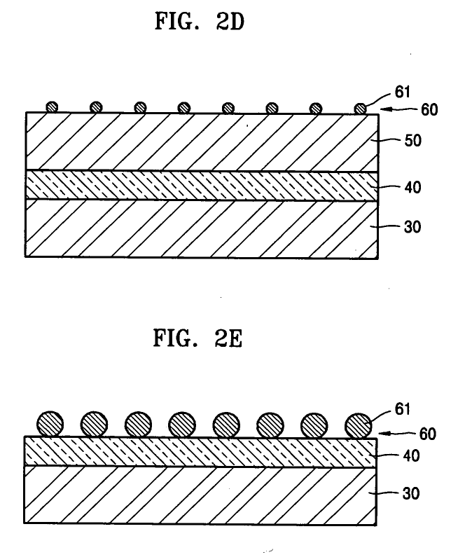

FIGS. 2A through 2E illustrate a method of manufacturing a nanoparticle structure according to another embodiment of the present invention.

Referring to FIG. 2A, first, a substrate 30 is prepared.

Referring to FIGS. 2B and 2C, an insulating layer 40 is formed on the substrate 30, and a silicon source layer 50 is formed on the insulating layer 40. The insulating layer 40 may be formed of SiO₂.

The silicon source layer 50 includes silicon and supplies silicon required for growing nanoparticles 61.

Referring to FIG. 2D, the nanoparticles 61 are deposited on the silicon source layer 50, thereby forming a nanoparticle layer 60. The nanoparticles 61 may be obtained by performing laser ablation on the target formed of Au and silicon.

Referring to FIG. 2E, the nanoparticles 61 are grown. The growth size of the nanoparticles 61 may be determined according to a thickness of the silicon source layer 50.

In an embodiment of the present invention, the size of the nanoparticles 61 can be adjusted by adjusting the thickness of the silicon source layer 50. In addition, since the substrate 30 and the nanoparticles 61 are isolated by the insulating layer 40 from each other, the nanoparticles 61 can be applied to a variety of devices.

As described above, in the nanoparticle structure and the method of manufacturing the nanoparticle structure according to the present disclosure, the size of nanoparticles can be adjusted by adjusting the thickness of the silicon source layer such that nanoparticles having a desired size can be easily obtained.

While the present invention has been particularly shown and described with reference to exemplary embodiments thereof, it will be understood by those skilled in the art that various changes in form and details may be made therein without departing from the spirit and scope of the invention as defined by the following claims.

What is claimed is:

1. A nanoparticle structure comprising:
a substrate; and
nanoparticles formed on the substrate,
wherein the nanoparticles include silicide.

2. The nanoparticle structure of claim 1, wherein the silicide is a silicide of one element selected from the group consisting of Au, Fe, Al, Co, Ni, Cu, Ag, and Pt.

3. The nanoparticle structure of claim 1, wherein the nanoparticles are formed through laser ablation.

4. The nanoparticle structure of claim 1, wherein the nanoparticles are grown through post annealing.

5. The nanoparticle structure of claim 4, wherein a post annealing temperature is 360° C. to 1400° C.

6. The nanoparticle structure of claim 1, wherein the substrate includes silicon.

7. The nanoparticle structure of claim 1, further comprising an insulating layer between the nanoparticles and the substrate.

8. The nanoparticle structure of claim 7, wherein the insulating layer is formed of at least one high-dielectric material selected from the group consisting of SiO₂, Si₃N₄, Ta₂O₃, ZrO₂, Al₂O₃, HfO₂, HfSiO₄, and HfAlO₄.

9. The nanoparticle structure of claim 1, wherein the nanoparticles are substantially formed in a spherical form.

10. A method of manufacturing a nanoparticle structure, the method comprising:
forming an Si source layer to a predetermined thickness;
forming nanoparticles using a predetermined metal and silicon;
depositing the nanoparticles on the Si source layer; and
growing the nanoparticles to form silicide.

11. The method of claim 10, wherein the metal includes at least one selected from the group consisting of Au, Fe, Al, Co, Ni, Cu, Ag, and Pt.

12. The method of claim 10, wherein the forming of the nanoparticles is performed through laser ablation.

13. The method of claim 10, wherein the growing of the nanoparticles is performed through post annealing.

14. The method of claim 13, wherein a post annealing temperature is 360° C. to 1400° C.

15. The method of claim 10, wherein the forming of the Si source layer comprises:
preparing a substrate; and
forming an insulating layer on the substrate; and
forming the Si source layer on the insulating layer.

16. The method of claim 15, wherein the substrate includes silicon.

17. The method of claim 15, wherein the insulating layer is formed of at least one high-dielectric material selected from the group consisting of SiO₂, Si₃N₄, Ta₂O₃, ZrO₂, Al₂O₃, HfO₂, HfSiO₄, and HfAlO₄.
